(19) United States
(12) Patent Application Publication
(10) Pub. No.: US 2013/0206841 A1
(43) Pub. Date: Aug. 15, 2013

(54) Apparatus and methods for securing data in a multilayered foil laminate incorporating faraday pouch properties and retrieving the data by removal of part or the entire faraday pouch for exposure of data for retrieval by NFC or RFID systems.

(71) Applicant: Geoffrey Ian Cairns, Redmond, WA (US)

(72) Inventor: Geoffrey Ian Cairns, Redmond, WA (US)

(21) Appl. No.: 13/587,878

(22) Filed: Aug. 16, 2012

Related U.S. Application Data
(60) Provisional application No. 61/524,324, filed on Aug. 17, 2011.

(51) Int. Cl. G06K 19/077

(52) U.S. Cl. CPC G06K 19/0776
USPC 235/488; 156/60; 156/277

(57) ABSTRACT

A multilayered foil laminate NFC-enabled sticker with a scratchable Faraday Pouch, which will prevent a user from reading the NFC data on a card unless the sticker is scratched off. The card includes an outside of the card next to scratchable Faraday cover made up of a foil laminate, which can be removed to expose the RFID readable data. The next layer is an adhesive that attaches the foil laminate, which attaches to the RFID/NFC Data sticker that contains the IC and antenna. This is followed by another adhesive that attaches to another Faraday layer followed by an optional printing layer on which custom messages and designs can be printed on a substrate material, which is on the outside of the sticker.

### PRIORITY CLAIMS

This application claims priority from Provisional Application Ser. No. 61/524,324 filed on Aug. 17, 2011, which is incorporated herein by reference in its entirety.

### FIELD OF INVENTION

Near Field Communications devices and tags.

### BACKGROUND

Cross-References to Related Applications
PCT US 2011/064173 Hand-held Self-Provisioned PIN PED Communicator

NFC “hotspots” allow a user with an NFC-enabled device, such as a PadLoc, Avakins, or Smartphone device, to read data by bringing the device within 3-4″ of the hotspot. The NFC-enabled device communicates and exchanges data with the hotspot using RFID-based signals. The data exchanged with the hotspot typically includes information relevant to the description around the hotspot including audio, video, a link to a location on the internet, or to otherwise provide data to the device for applications that the device may be running.

NFC hotspots have been traditionally implemented using an NFC “Sticker” or “Tag.” These stickers are made up of an integrated circuit (IC), containing information to be shared with an NFC device, connected by an antenna typically made of coiled conductive wire used to send and receive signals from the NFC-enabled device within a certain range. The antenna and IC are typically on a polymer or other substrate material that can be thin and flexible enough to allow the sticker to be placed on a bendable surface, such as on a ticket-sized piece of paper, sheet of paper used as a poster, or as a page in a book or magazine.

For example, Wired Magazine in their April 2012 issue, ran an advertisement for Lexus Automobiles that contained a single NFC hotspot using an NFC sticker in each of Wired's 550,000 copy print run. When magazine readers brought their NFC devices near the hotspot, information about Lexus products appeared on the devices and users were also directed to a website for more information.

An NFC sticker may also be used as a prize or a lotto card, or some other single-redemption card that is currently implemented today as a “scratch-off” card. Today, when a user purchases a lottery ticket or receives a single-redemption offer, the user typically scratches off the protective coating that hides the offer's value. Once exposed and redeemed, the prize or redemption card cannot be used again. In this way offer providers limit their exposure.

In the NFC example, a user would purchase an NFC-enabled lottery card, or receive an NFC-enabled card as part of a purchase or promotion, or as a redemption coupon within a product such as inside a cereal box. The challenge with using NFC as a method of redemption is that multiple people could use NFC readers to electrically read the coupon multiple times without a physical change to the card showing that the data on the NFC card has been scanned.

To prevent the multiple-read situation, the card would be covered in a Faraday Shield protective coating that would make the card unreadable by an NFC reader. A Faraday Shield is an enclosure formed by conducting material or by a mesh of such material. Such an enclosure blocks external static and non-static electric fields, preventing NFC communication between the card and the NFC reader. http://en.wikipedia.org/wiki/Faraday cage.

To read the card with an NFC reader, the user would remove the Faraday Shield on the card that is covering the NFC antenna by scratching off or otherwise removing the Shield.

The card would then be assured only a single use either through (1) physical property changes in the card due to the scratch-off, (2) a change recorded in the IC on the NFC Sticker causing it to no longer be active, or (3) the recording of the data found in the IC in a central database that is registered on a central computer system and accessed by the user's NFC device reader.

Scratch-off card Patents:

US 2004/0026915 A1: Multi-Purpose Card (Thompson). A multi-purpose card includes a combination of a plurality of coupons detachably cut into the redemption card, a bar code imprinted onto the redemption card, integrated circuit chips, and/or a scratch-off foil overlying an offer or information printed on the card. The multi-purpose card may be housed integrally in a promotional mailer in the form of a two-piece in one post card. The card is created and defined within the promotional mailer by score lines intermittently cut through a top layer, base layer and plastic film of the mailer in a manner to securely maintain the card in place until forcibly removed.

NFC-enabled card patents

U.S. Pat. No. 6,747,547: Communication Method and Apparatus Improvements

Therefore, there is a need for Multilayered Foil Laminate Faraday Processing that is not being met in the marketplace today.

This and all other referenced patents and applications are incorporated herein by reference in their entirety. Furthermore, where a definition or use of a term in a reference, which is incorporated by reference herein is inconsistent or contrary to the definition of that term provided herein, the definition of that term provided herein applies and the definition of that term in the reference does not apply.

### SUMMARY OF THE INVENTION

A multilayer foil laminate sticker for RFID and the method of creating it made up of a scratchable Faraday Cover adhered to an RFID or NFC Data-enabled sticker adhered to another Faraday layer all on a substrate.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a diagram of a Multilayered Foil Laminate NFC-enabled Sticker with Scratchable Faraday Pouch.

### DETAILED DESCRIPTION

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

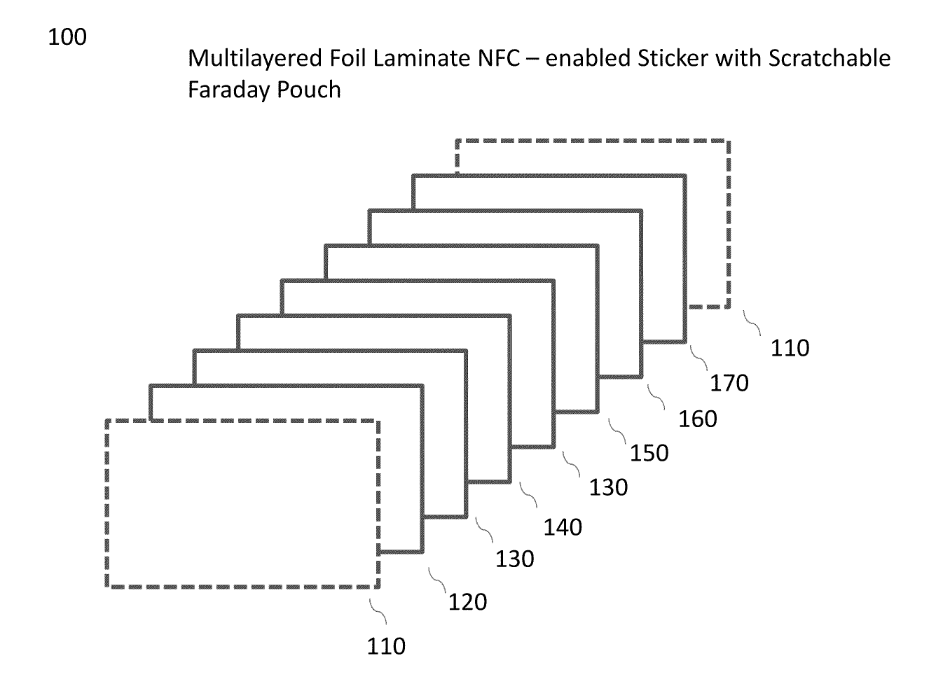

FIG. 1 illustrates a Multilayered Foil Laminate NFC-enabled Sticker with a scratchable Faraday Pouch which will prevent a user from reading the NFC data on the card unless the sticker is scratched off. The card consists of an outside of the card (110) next to scratchable Faraday cover (120) made up of a foil laminate which can be removed to expose the RFID readable data. The next layer is an adhesive (130) that attaches the foil laminate which attaches to the RFID / NFC Data sticker (140) that contains the IC and antenna. This is followed by another adhesive that attaches to another Faraday layer (150) followed by an optional printing layer on which custom messages and designs can be printed on a substrate material (170) which is on the outside of the sticker (110).

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

Thus, specific compositions and methods of providing multilayered foil laminate Faraday Processing have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed:

1. A multilayer foil laminate sticker for RFID comprising:
a. A Scratchable Faraday Cover
b. An adhesive
c. An RFID/NFC data
d. An adhesive
e. A Faraday layer
f. a Substrate

2. A multilayer foil laminate sticker as in claim 1, further comprising:
a. A printed layer

3. A method for creating a scratchable foil laminate product comprising:
a. A means for attaching a scratchable Faraday cover
b. A means for adhering said Faraday cover to an RFID/NFC data antenna/IC combination
c. A means for adhering said RFID/NFC data antenna/IC combination to a second Faraday cover
d. A means for adhering said second Faraday cover to a substrate

4. A method for creating a scratchable foil laminate product in claim 3 further comprising:
a. A means for printing onto said substrate.
